(19) United States
(12) Patent Application Publication
(10) Pub. No.: US 2007/0266763 A1
(43) Pub. Date: Nov. 22, 2007

(54) FOOTWEAR TESTING MACHINE

(76) Inventors: Ron Therrio, Silverado, CA (US); Jeremy Determan, Newport Beach, CA (US); Joseph Cox, Lake Forest, CA (US); Matthew Nevitt, Rancho Santa Margarita, CA (US)

Correspondence Address: MARC E. HANKIN, ESQ., 11414 THURSTON CIRCLE, LOS ANGELES, CA, 90049, US

(21) Appl. No.: 11/419,458

(22) Filed: May 19, 2006

(51) Int. Cl. G01N 3/30

(52) U.S. Cl. 73/12.01; 73/12.09

(57) ABSTRACT

This invention discloses a footwear testing device that evaluates the durability of footwear to the wear encountered in the sport of skateboarding.

### FIELD OF INVENTION

This invention relates, generally, to testing machines for footwear; more particularly, to testing machines for footwear that replicate the wear to footwear caused by the sport of skateboarding.

### BACKGROUND

The art of footwear testing has developed numerous machines for testing the wear borne by footwear in the course of their daily use. These machines, by replicating and accelerating the effects of wear that footwear receives from friction, impact with the floor, and other pressures, allow footwear manufacturers to evaluate design and materials used to maximize their durability.

One such machine is disclosed by U.S. Pat. No. 2,638,776 to Aines which discloses a mechanical footwear testing machine for testing the durability of shoes by simulating the pressures shoes encounter during walking. Aines' device consists of a rotating wheel that mounts a number of shoes at the circumferential edge of the wheel. As the wheel rotates, the shoe located at the lowermost position comes into contact with a simulated floor in a manner that approximates the pressures encountered by the shoe when a wearer takes a step. By rotating the wheel hundreds of times, the machine allows a shoe manufacturer to evaluate the wear, encountered by shoes over the course of many months of wear, in a relatively short amount of time.

Another such device is taught by U.S. Pat. No. 3,608,372 to Hovey et al. Hovey's device discloses a machine for evaluating the attachment of shoe soles to shoe uppers. The device operates by fixing the shoe in place while repeatedly applying forces to the shoe sole, in order to create a separative stress between the sole and the shoe upper. In this manner, the machine allows the user to evaluate the strength of attachment between the shoe sole and the shoe upper and, thus, the durability of the shoe.

Another machine for testing shoe soles is disclosed by U.S. Pat. No. 4,096,733 to Cohen. Cohen's device comprises a machine that includes a treadmill and a rotating mount for shoe soles. The device operates by rotating the shoe sole over the treadmill in order to simulate the pressures encountered by the shoe sole in walking. Like Aines' device, above, Cohen's machine allows the user to evaluate the longevity of shoe soles by accelerating the effects of wear on the shoe sole.

Another footwear testing machine is taught by U.S. Pat. No. 4,130,007 to Hayashi, which teaches a mechanism that simulates walking by pivoting a shoe and applying upwards force to the shoe sole by a movable mechanism that simulates a floor. Hayashi's device, thus, allows the user to evaluate the wear borne by shoes in the course of walking. U.S. Pat. No. 4,327,572 to Pitman et al. discloses a similar device that evaluates the wear on shoes by simulating the motion of a runner's leg. Another, similar device is disclosed by U.S. Pat. No. 4,432,223 to Paquette et al., which mounts a shoe for testing to a movable pylon that simulates the motion of the knee and ankle of a wearer, in order to simulate walking.

Further such devices are disclosed by U.S. Pat. Nos. 6,289,743 and 6,988,416 to Norton, which teaches a device that allows a user to apply stresses and strains to a shoe using levers and gauge the stresses and strains. Norton's device allows the user to evaluate a shoe's durability by stretching, stressing, ramming, and torquing the shoe in order to evaluate its durability to forces encountered when worn.

While the above machines successfully evaluate the durability of the shoe sole in walking and running, none of these devices test the wear that other portions of the shoe encounters in unique sports activities. Specifically, none of the devices teaches a mechanism for evaluating the stresses and stains encountered by shoes worn in the sport of skateboarding.

Another class of testing devices has been developed to evaluate the durability of other fabrics and garments. U.S. Pat. No. 3,312,100 to Ainslie, for example, teaches a device for impact testing the characteristics, construction, and wearing possibilities of fabrics. Ainslie's device operates by mounting sections of fabric to arms extending from a rotating disk. As the disk rotates, the fabric is pressed by centrifugal force to come in contact with abutments located beyond the arms of the disk. In this manner, the durability of the fabric is tested. This device, however, is not useful for evaluating the durability of shoes or for simulating the wear encountered in the sport of skateboarding.

Other fabric testing devices are disclosed by U.S. Pat. Nos. 4,936,135 to Annis et al. and 5,795,989 to Simmons et al. Annis' device tests the durability of fabrics by mounting fabrics to two rotating discs that are allowed to come into contact with one another and evaluate the wear of the fabric. Simmons' device, meanwhile, teaches a mechanism for testing fabrics by applying abrasive forces to the fabrics and then evaluating the wear caused by the abrasive forces. While successful in evaluating fabric wear, neither of these devices is suitable for mounting shoes or evaluating the wear caused to shoes by the sport of skateboarding.

Thus, there remains a long-felt need in the art for a footwear testing machine that evaluates the footwear's resistance to the unique wear caused to footwear by the sport of skateboarding.

### SUMMARY OF THE INVENTION

This invention is directed towards overcoming the above shortcomings by teaching a footwear testing machine that subjects footwear to the unique forces, stresses, and strains encountered in the sport of skateboarding. Many of the tricks performed by skateboarders subject the rider's shoe to unique wear, that is not encountered in walking, running, or other sports.

For example, the “ollie” or “ollie-pop” is a jumping maneuver often performed by skateboarders and forms the basis for many other skateboarding tricks. (See: “The Physics of Skateboarding Tricks:” http://www.exploratorium.edu/skateboarding/trick02.html, for a detailed discussion of the forces encountered in an ollie). As part of the ollie, when the rider is in the air, the rider slides his or her front foot forward against the skateboard deck to drag the board higher into the air and level the skateboard deck. This motion causes unique wear to the skateboarder's shoe because the upper-front portion of the shoe is forced against the skateboard deck, which usually has a rough, sandpaper-like texture.

Another basic skateboarding trick that causes unique wear to the rider's shoe is commonly referred to as the kickflip. The kickflip is a variation on the ollie, wherein the rider flicks his or her front foot against the edge of the skateboard, causing it to rotate along its lengthwise axis while the rider and the skateboard are in the air. When the rider flicks his or her front foot, the kickflip also causes unique wear to the wearer's shoe because the upper-front portion of the shoe is rubbed against the skateboard deck's rough surface. Numerous other skateboarding tricks built upon the ollie and kickflip similarly subject the upper-front portion of the wearer's shoe to unique wear.

Skateboarding shoe manufacturers, thus, generally manufacture shoes with additional reinforcements at the upper-front portions of the shoe to reinforce against the greater wear caused by skateboarding tricks. As noted above, however, there remains a long-felt need in the art for a machine for testing and evaluating a shoe's durability in light of the stresses and strains caused by skateboarding tricks.

This invention overcomes the shortcomings of the prior art by, in one embodiment of the invention, disclosing a testing machine that can simulate the stresses on the shoe's upper caused by ollies, kickflips, and other skateboarding tricks. A skateboard deck is mounted to the machine by a mounting arm that allows the position and angle of the deck to be adjusted, but fixedly maintains the deck's position when the machine is in operation. The mounting arm also includes a flexible articulating joint, which allows the skateboard deck to slightly move on impact with the shoe. The machine also includes a rotating disk, which mounts a shoe, such that the shoe extends outwards from the plane of the rotating disk. The rotating disk and mounting arm are positioned relative to one-another such that, when the machine is operated, the upper-front of the shoe impacts the skateboard deck, such that the machine approximates the forces and stresses encountered by shoes when the wearer performs ollies, kickflips, and other skateboarding tricks. In this manner, the machine operates to simulate the stresses encountered by skateboarding shoes over the course of many months of use and wear. Thus, the invention overcomes the shortcomings of the prior art by allowing footwear to be tested for its resistance to the wear caused by the sport of skateboarding.

In another embodiment of the invention, the rate of rotation of the rotating wheel can be adjusted by the machine operator.

In another embodiment of the invention, the mounting arm mounts a shoe, rather than a skateboard deck, and the deck is mounted to the rotating portion of the machine. This embodiment of the invention similarly replicates the stresses encountered by the skateboard shoe as the rotating skateboard deck is forced against the fixed shoe.

In yet another embodiment of the invention, the machine includes a device for counting and displaying the number of impacts between the skateboard deck and the shoe, thus, allowing the machine operator to monitor the number of impacts the shoe makes with the deck.

In yet another embodiment of the invention, the machine includes a force transducer and display for monitoring the amount of force encountered in each impact of the shoe to the skateboard deck. In this manner, the machine operator can adjust the position of the deck or shoe to provide a specific amount of force one each impact.

In yet another embodiment of the invention, the machine includes a device and display for monitoring the amount of time that has been spent on a given test.

In yet another embodiment of the invention, the rotating disk includes two or more shoe mounts. Thus, by allowing two or more shoes to be evaluated under identical conditions, the operator can compare the durability of two or more shoes on the machine at the same time.

In yet another embodiment of the invention, the machine can mount two or more skateboarding decks, such that a shoe impacts two or more decks on a given rotation. In this manner, the machine allows the operator to approximate the wear caused by skateboarding tricks wherein the shoe impacts the deck more than one time or in more than one position.

It should be noted that, in the interests of clarity, numerous details for the functionality of the footwear testing machine and variations on the configuration of the footwear testing machine are not included in this disclosure. Nevertheless, these details are known within the art and the variations remain within the contemplation of this invention.

In summary, the invention teaches a machine for testing the durability of shoes to the stresses and forces encountered in the sport of skateboarding.

### BRIEF DESCRIPTION OF THE DRAWINGS

FIG. 1A is an illustration from a perspective view of a skateboard rider performing an ollie.

FIG. 1B is an illustration from a top view of the wear typically caused to footwear by skateboarding tricks.

FIG. 2 is an illustration from a perspective view of one embodiment of the invention.

FIG. 3 is a detailed illustration from a perspective view of the mounting arm in one embodiment of the invention.

FIG. 4A is an illustration from a side view of one embodiment of the invention.

FIG. 4B is a detailed illustration from a perspective view of one embodiment of the invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance, “shoe” refers to any article of footwear or other covering of the human foot; “skateboard deck” refers to any plank or generally flat surface, with or without a rough texture, that can be used to approximate a skateboard deck on the machine.

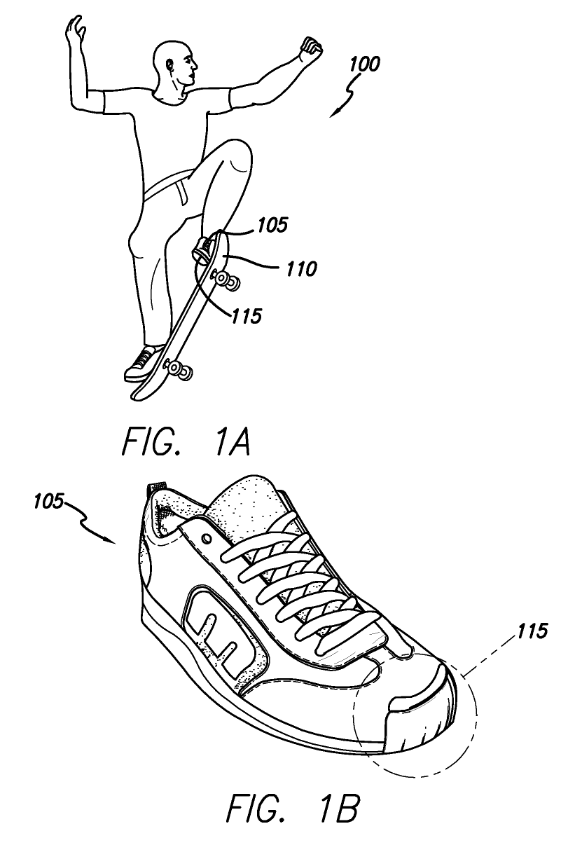

FIG. 1A is an illustration from a perspective view of a skateboard rider 100 performing an ollie. The skateboard rider's 100 front foot 105 is shown as it impacts the skateboard deck 110 when performing the ollie maneuver and results in unique wear to the upper-front area 115 of the rider's shoe.

FIG. 1B is an illustration from a top view of the wear typically caused to footwear by skateboarding tricks. A shoe 105 is shown with the area 115 that is typically worn by skateboarding tricks.

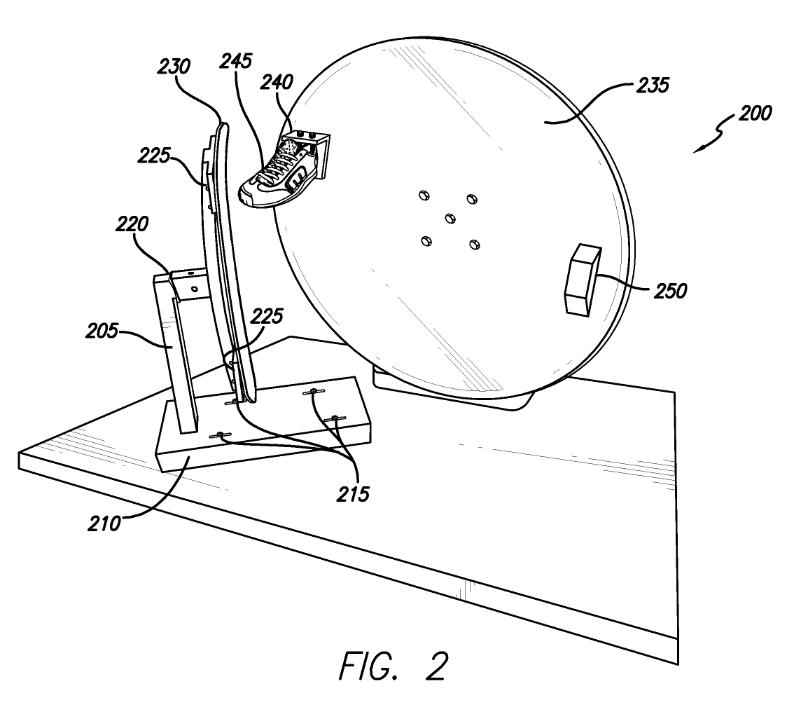

FIG. 2 is an illustration from a perspective view of one embodiment of the invention. A footwear testing machine 200 is shown along with its constituent parts, including the mounting arm 205 and the rotating disk 235. The mounting arm 205 features a base 210 and several position adjusting screws 215, which allow the position of the mounting arm 205 to be adjusted by the machine operator. The mounting arm 205 also features a flexible articulating joint 220, which allows the skateboard deck 230 to slightly flex, when impacted by the shoe 245. The mounting arm 205 also includes deck mounts 225 for attaching a skateboard deck 230 to the mounting arm 205. The rotating disk 235 features a shoe mount 240, which attaches a shoe 245 to the footwear testing machine 200. The rotating disk 235 also features a counterweight 250, at a position on the disk opposite the shoe 245, in order to balance the weight of the shoe 245.

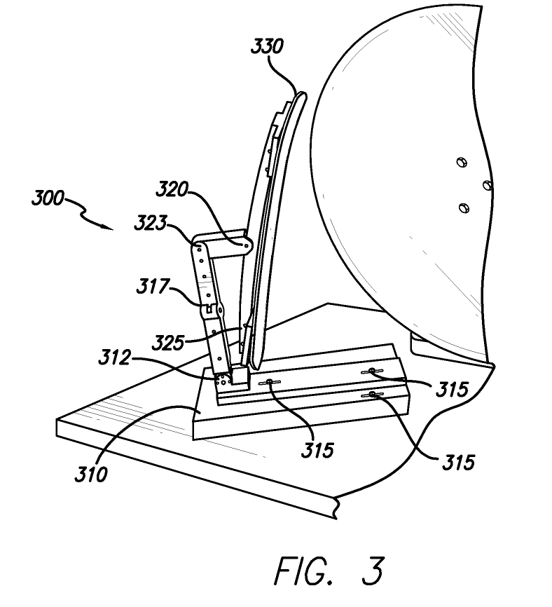

FIG. 3 is a detailed illustration from a perspective view of the mounting arm 300 in one embodiment of the invention. A mounting arm 300 is shown along with its constituent parts, including the base 310, which includes several position adjusting screws 315, which allow the position of the mounting arm 300 to be adjusted by the machine operator. The mounting arm 300 also features several adjustable joints 312, 317, and 323, which allow the position and angle of the skateboard deck 330 to be precisely adjusted by the machine operator. Also, the mounting arm 300 features a flexible articulating joint 320, which allows the skateboard deck 330 to slightly flex, when impacted by the shoe. The skateboard deck 330 is attached to the mounting arm 300 by deck mounts 325.

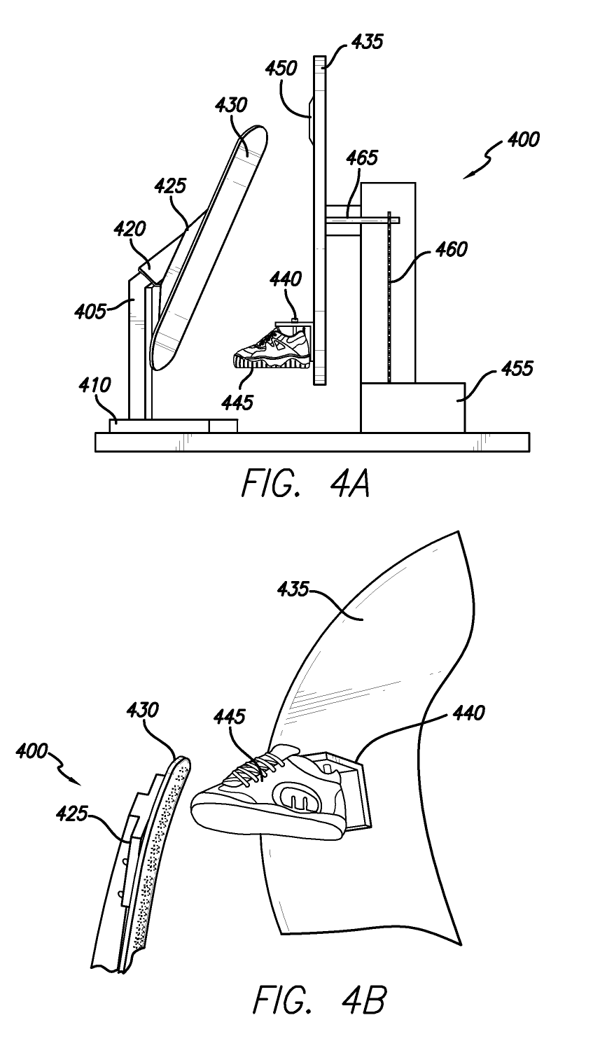

FIG. 4A is an illustration from a side view of one embodiment of the invention. A footwear testing machine 400 is shown along with its constituent parts, including the mounting arm 405 and the rotating disk 435. The mounting arm 405 features a base 410 and several position adjusting screws, which allow the position of the mounting arm 405 to be adjusted by the machine operator. The mounting arm 405 also features a flexible articulating joint 420, which allows the skateboard deck 430 to slightly flex, when impacted by the shoe 445. The mounting arm 405 also includes deck mounts 425 for attaching a skateboard deck 430 to the mounting arm 405. The rotating disk 435 features a shoe mount 440, which attaches a shoe 445 to the footwear testing machine 400. The rotating disk 435 also features a counterweight 450, at a position on the disk opposite the shoe 445, in order to balance the weight of the shoe 445. The rotating disk 435 is mounted to an axle 465, which is driven by a chain 460, connected to a motor 455.

FIG. 4B is a detailed illustration from a perspective view of one embodiment of the invention. A footwear testing machine 400 is shown along with its constituent parts, including the deck mount 425 and skateboard deck 430. The rotating disk 435 is also shown along with the shoe mount 440 and shoe 445.

What is claimed is:

1. A machine for testing footwear, comprising:
a rotating arm, said rotating arm having a pivot at its proximal end and said rotating arm being mounted to a rotation mechanism,
said rotating arm further having a mount at its distal end, said mount being configured to attach footwear,
a mounting arm, said mounting arm being configured to mount a plank,
said rotating arm and said mounting arm being configured such that, when footwear is attached to said rotating arm and said rotating arm is rotated, said footwear impacts said plank.

2. A machine for testing footwear according to claim 1, wherein said rotating arm is in the shape of a disk, with the pivot being located at the center of the disk and the mount being located at a point proximate to the circumference of said disk.

3. A machine for testing footwear according to claim 1, wherein said mounting arm includes an adjustment mechanism for adjusting the position of said plank relative to said rotating arm.

4. A machine for testing footwear according to claim 2, wherein said mounting arm includes an adjustment mechanism for adjusting the position of said plank relative to said rotating arm.

5. A machine for testing footwear according to 1, wherein said plank is a skateboard deck.

6. A machine for testing footwear according to claim 2, wherein said plank is a skateboard deck.

7. A machine for testing footwear according to claim 3, wherein said plank is a skateboard deck.

8. A machine for testing footwear according to claim 4, wherein said plank is a skateboard deck.

9. A machine for testing footwear, comprising:
a rotating disk, said rotating disk having a pivot at its center end and said rotating disk being mounted to a rotation mechanism,
said rotating disk further having one or more mounts at points proximal to the circumference of said rotating disk, said mounts being configured to attach footwear,
a mounting arm, said mounting arm being configured to mount a skateboard deck,
said mounting arm being further configured such that the position and angle of said skateboard deck relative to said rotating disk is adjustable,
said mounting arm further including a flexible articulating joint, such that said flexible articulating joint allows said skateboard deck to be slightly displaced upon impact with said footwear,
said rotating disk and said mounting arm being configured such that, when footwear is attached to said rotating disk and said rotating disk is rotated, said footwear impacts said skateboard deck.

10. A machine for testing footwear, comprising:
a rotating disk, said rotating disk having a pivot at its center end and said rotating disk being mounted to a rotation mechanism,
said rotating disk further having one or more mounts at points proximal to the circumference of said rotating disk, said mounts being configured to attach footwear,
a mounting arm, said mounting arm being configured to mount a skateboard deck,
said mounting arm being further configured such that the position and angle of said skateboard deck relative to said rotating disk is adjustable,
said mounting arm further including a flexible articulating joint, such that said flexible articulating joint allows said skateboard deck to be slightly displaced upon impact with said footwear,
said rotating disk and said mounting arm being configured such that, when footwear is attached to said rotating disk and said rotating disk is rotated, said footwear impacts said skateboard deck at or proximate to the upper of said footwear.

11. A machine for testing footwear according to claim 1, wherein said machine includes a means for adjusting the rate of rotation of said rotating arm.

12. A machine for testing footwear according to claim 9, wherein said machine includes a means for adjusting the rate of rotation of said rotating arm.

13. A machine for testing footwear according to claim 10, wherein said machine includes a means for adjusting the rate of rotation of said rotating arm.

14. A machine for testing footwear according to claim 9, wherein said rotating disk mounts a skateboard deck and said mounting arm mounts a shoe.

15. A machine for testing footwear according to claim 10, wherein said rotating disk mounts a skateboard deck and said mounting arm mounts a shoe.

16. A machine for testing footwear according to claim 1, wherein said machine includes a mechanism for counting and displaying the number of impacts said footwear makes with said skateboard deck.

17. A machine for testing footwear according to claim 9, wherein said machine includes a mechanism for counting and displaying the number of impacts said footwear makes with said skateboard deck.

18. A machine for testing footwear according to claim 10, wherein said machine includes a mechanism for counting and displaying the number of impacts said footwear makes with said skateboard deck.

19. A machine for testing footwear according to claim 1, wherein said machine includes a mechanism for monitoring and displaying the force with which said footwear impacts said skateboard deck.

20. A machine for testing footwear according to claim 9, wherein said machine includes a mechanism for monitoring and displaying the force with which said footwear impacts said skateboard deck.

21. A machine for testing footwear according to claim 10, wherein said machine includes a mechanism for monitoring and displaying the force with which said footwear impacts said skateboard deck.

22. A machine for testing footwear according to claim 1, wherein said machine includes a mechanism for timing and displaying the amount of time that said rotating arm is rotated.

23. A machine for testing footwear according to claim 9, wherein said machine includes a mechanism for timing and displaying the amount of time that said rotating disk is rotated.

24. A machine for testing footwear according to claim 10, wherein said machine includes a mechanism for timing and displaying the amount of time that said rotating disk is rotated.

25. A machine for testing footwear according to claim 1, wherein said machine includes a means for adjusting the rate of rotation of said arm.

26. A machine for testing footwear according to claim 9, wherein said machine includes a means for adjusting the rate of rotation of said arm.

27. A machine for testing footwear according to claim 10, wherein said machine includes a means for adjusting the rate of rotation of said arm.

28. A machine for testing footwear according to claim 1, wherein said mounting arm includes a flexible portion, such that, when said footwear impacts said skateboard deck, said skateboard deck is slightly displaced.

29. A machine for testing footwear according to claim 1, wherein said machine includes a second mounting arm, said second mounting arm being configured to attach a second plank.

30. A machine for testing footwear according to claim 9, wherein said machine includes a second mounting arm, said second mounting arm being configured to attach a second skateboard deck.

31. A machine for testing footwear according to claim 10, wherein said machine includes a second mounting arm, said second mounting arm being configured to attach a second skateboard deck.
